(19) United States
(12) Patent Application Publication
(10) Pub. No.: US 2020/0172027 A1
(43) Pub. Date: Jun. 4, 2020

(54) WIRING HARNESS AND METHOD OF MANUFACTURING WIRING HARNESS

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Housei MIZUNO, Mie (JP); Hiroki HIRAI, Mie (JP); Toyoki FURUKAWA, Mie (JP); Yasuyuki OTSUKA, Mie (JP); Miyu ARAMAKI, Mie (JP)

(73) Assignees: AutoNetworks Technologies, Ltd., Mie (JP); SUMITOMO WIRING SYSTEMS, LTD., Mie (JP); SUMITOMO ELECTRIC INDUSTRIES, LTD., Osaka (JP)

(21) Appl. No.: 16/621,030

(22) PCT Filed: Jun. 19, 2018
(86) PCT No.: PCT/JP2018/023188

§ 371 Date: Dec. 10, 2019

(30) Foreign Application Priority Data
Jun. 19, 2017 (JP) 2017-119772
Nov. 9, 2017 (JP) 2017-216189

(51) Int. Cl. B60R 16/02; H01B 13/012; H01B 7/00; H01R 43/02

(52) U.S. Cl. CPC B60R 16/0215; H01B 13/012; H01R 43/0221; H01R 43/0207; H01B 7/00

(57) ABSTRACT

A wire harness includes a sheet material, an electrical wire, and a holding part. The electrical wire includes a core wire and an insulating covering which directly covers a periphery of the core wire and is disposed along the sheet material. The holding part, at least a part of which intervenes between the electrical wire and the sheet material, mediates a bonding between the sheet material and the electrical wire by welding.

### TECHNICAL FIELD

The present invention relates to a technique of attaching electrical wires to an exterior member in a wire harness for vehicle.

### BACKGROUND ART

Patent Document 1 discloses a technique, when a sheet-shaped exterior member is attached to electrical wires, for positioning the exterior member with respect to the electrical wires by winding a tape around each end portion of the exterior member and the electrical wires extending from the end portion.

### PRIOR ART DOCUMENTS

### Patent Documents

Patent Document 1: Japanese Patent Application Laid-Open No. 2015-72798

### SUMMARY

### Problem to be Solved by the Invention

Herein, the applicant of the present application proposes, as a new method of fixing the electrical wires and the exterior member, a method of directly fixing an insulating covering of the electrical wires and a sheet material by a welding means such as ultrasonic welding or laser welding.

However, there is a possibility that sufficient fixing strength cannot be obtained when a material of the electrical wires and a material of the sheet material are not compatible with each other or a welding area is small.

An object of the present invention is to provide a technique more appropriate for fixing electrical wires and a sheet material by a welding means such as ultrasonic welding or laser welding.

### Means to Solve the Problem

In order to solve the above problem, a wire harness according to a first aspect includes: a sheet material; an electrical wire including a core wire and an insulating covering which directly covers a periphery of the core wire and disposed along the sheet material; and a holding part, at least a part of which intervenes between the electrical wire and the sheet material to mediate a bonding between the sheet material and the electrical wire by welding.

The wire harness according to a second aspect is the wire harness according to the first aspect, wherein the holding part includes a sheet material-side holding part provided on the sheet material.

The wire harness according to a third aspect is the wire harness according to the second aspect, wherein at least part of the electrical wire is buried in the sheet material-side holding part.

The wire harness according to a fourth aspect is the wire harness according to the third aspect, wherein the sheet material-side holding part is formed softer than the sheet material while using, as a base, a resin identical with a resin used in the sheet material as a base.

The wire harness according to a fifth aspect is the wire harness according to the fourth aspect, wherein a resin used in the insulating covering as a base is identical with the resin used in the sheet material-side holding part as the base.

The wire harness according to a sixth aspect is the wire harness according to any one of the first to fifth aspects, wherein the holding part includes an electrical wire-side holding part provided on the electrical wire to fix the electrical wire to the sheet material.

The wire harness according to a seventh aspect is the wire harness according to the sixth aspect, wherein the electrical wire-side holding part is continuously provided along a longitudinal direction of the electrical wire.

The wire harness according to an eighth aspect is the wire harness according to the sixth aspect, wherein the electrical wire-side holding part is intermittently provided along a longitudinal direction of the electrical wire.

A wire harness according to a ninth aspect is the wire harness according to any one of the sixth to eighth aspects, wherein the electrical wire-side holding part is provided over a whole periphery of the electrical wire.

The wire harness according to a tenth aspect is the wire harness according to any one of the sixth to eighth aspects, wherein the electrical wire-side holding part is provided only on part of a region in the electrical wire along a circumferential direction.

The wire harness according to an eleventh aspect is the wire harness according to any one of the sixth to tenth aspects, wherein the insulating covering and the sheet material are formed by materials different in type, and the electrical wire-side holding part is formed of a material welded more easily to the sheet material than the insulating covering to the sheet material.

A wire harness according to a twelfth aspect is the wire harness according to any one of the first to eleventh aspects, wherein the holding part mediates a bonding between the sheet material and the electrical wire by ultrasonic welding or laser welding.

A method of manufacturing a wire harness according to a thirteenth aspect includes: a step (a) of providing a holding part on at least one of a sheet material and an electrical wire; and a step (b) of making the holding part intervene between the sheet material and the electrical wire and melting the holding part, thereby bonding the sheet material and the electrical wire with the holding part therebetween.

A method of manufacturing a wire harness according to a fourteenth aspect is the method of manufacturing the wire harness according to the thirteenth aspect, wherein the step (a) includes a step (a1) of providing the holding part on the sheet material.

A method of manufacturing a wire harness according to a fifteenth aspect is the method of manufacturing the wire harness according to the thirteenth or fourteenth aspect, wherein the step (a) includes a step (a2) of providing the holding part on a periphery of the electrical wire, and performs the step (a2) and the step (b) together during one step of reeling out the electrical wire.

### Effects of the Invention

According to each aspect, the firm bonding between the electrical wire and the sheet material, using the ultrasonic welding or the laser welding, can be achieved when the holding part intervening between the electrical wire and the sheet material is formed of a material having favorable bonding characteristics with a material of a member of the electrical wire or the sheet material to which the holding part is welded by the ultrasonic welding and or the laser welding, for example.

According to the second aspect, the sheet material and the electrical wire can be welded by the ultrasonic welding or the laser welding using the sheet material-side holding part previously provided on the sheet material.

According to the third aspect, the welding area between the electrical wire and the sheet material-side holding part can be increased. Accordingly, the bonding strength can be increased.

According to the fourth aspect, the bonding portion between the electrical wire and the sheet material is pressed and the welding is performed in the state where the sheet material-side holding part warps at the time of the ultrasonic welding or the laser welding, thus the structure of burying the electrical wire in the sheet material-side holding part can be simply formed.

According to the fifth aspect, the electrical wire and the sheet material-side holding part can be welded easily. Accordingly, the bonding strength can be increased.

When the electrical wire and the sheet material are fixed by welding, there may be a case where the insulating covering melts at the time of welding, and a thickness of the insulating covering is reduced. Even in this case, according to the sixth aspect, the electrical wire-side holding part provided on the outer periphery of the insulating covering is welded to the sheet material, thus the insulating covering hardly melts. Thus, sufficient insulation properties can be ensured after welding.

According to the seventh aspect, an optional position in the electrical wire-side holding part along the longitudinal direction of the electrical wire can be welded to the sheet material.

According to the eighth aspect, a material saving and a weight saving can be achieved.

According to the ninth aspect, the electrical wire can be reliably held even when the electrical wire-side holding prat and the insulating covering are not bonded to each other.

According to the tenth aspect, a material saving and a weight saving can be achieved.

According to the eleventh aspect, sufficient holding strength can easily be obtained between the electrical wire and the exterior member after welding.

According to the fifteenth aspect, a lead time can be reduced.

### BRIEF DESCRIPTION OF DRAWINGS

FIG. 1 A perspective view illustrating a wire harness according to a first embodiment.

FIG. 2 A bottom view illustrating the wire harness according to the first embodiment.

FIG. 3 A cross-sectional view of the wire harness cut along a line in FIG. 2.

FIG. 4 An explanation diagram illustrating a method of manufacturing the wire harness according to the first embodiment.

FIG. 5 A perspective view illustrating a wire harness according to a second embodiment.

FIG. 6 A cross-sectional view of the wire harness cut along a VI-VI line in FIG. 5.

FIG. 7 An explanation diagram illustrating a method of manufacturing the wire harness according to the second embodiment.

FIG. 8 A perspective view illustrating a wire harness according to a third embodiment.

FIG. 9 A cross-sectional view of the wire harness cut along a IX-IX line in FIG. 8.

FIG. 10 A perspective view illustrating a wire harness according to a fourth embodiment.

FIG. 11 A cross-sectional view of the wire harness cut along an XI-XI line in FIG. 10.

FIG. 12 A cross-sectional view illustrating a wire harness according to a fifth embodiment.

FIG. 13 An explanation diagram illustrating a manufacture of the wire harness according to the fifth embodiment.

### DESCRIPTION OF EMBODIMENT(S)

### First Embodiment

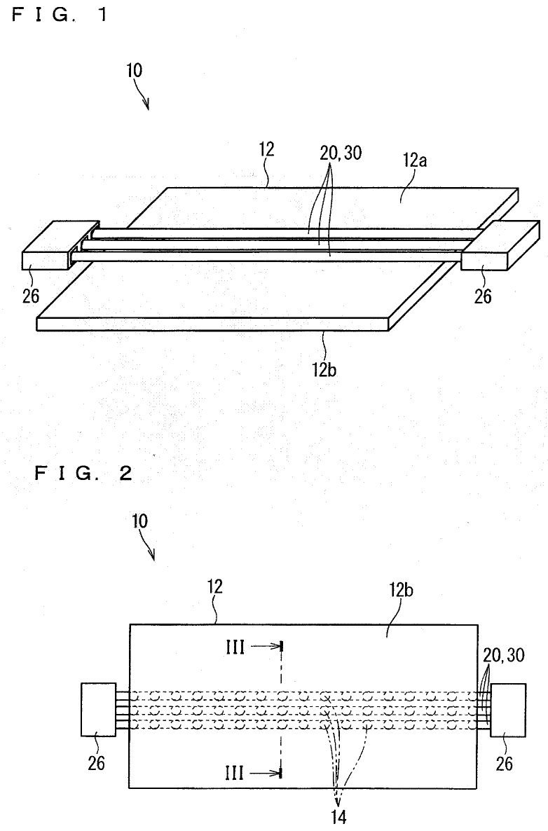

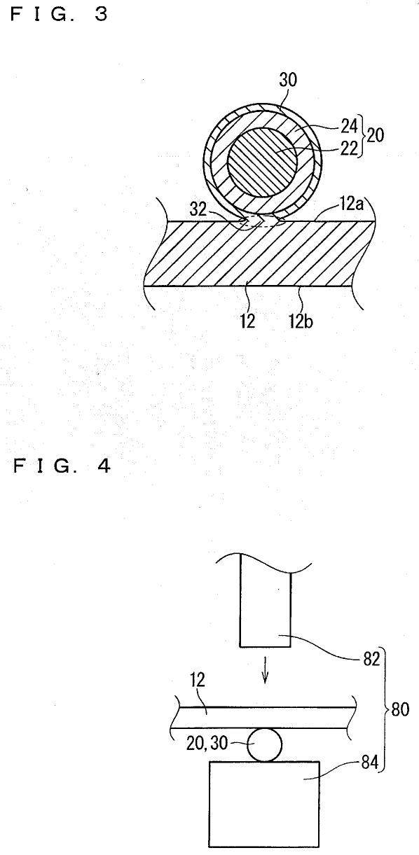

A wire harness according to a first embodiment is described hereinafter. FIG. 1 is a perspective view of a wire harness 10 according to the first embodiment. FIG. 2 is a bottom view illustrating the wire harness 10 according to the first embodiment. FIG. 3 is a cross-sectional view of the wire harness 10 cut along a line in FIG. 2. A part surrounded by an imaginary line in FIG. 3 indicates a position where the sheet material 12 and a holding part 30 are welded to each other.

The wire harness 10 is used as a wiring for electrically connecting various electrical devices mounted on, for example, a vehicle. The wire harness 10 is routed around, for example, an installment panel, a roof, and a door in the vehicle. Specifically, the wire harness 10 includes the sheet material 12, electrical wires 20, and the, holding part 30.

The sheet material 12 is a member exteriorly mounted on the electrical wires 20. The sheet material 12 is a member having at least one of functions of soundproofing (sound-damping, sound absorption, sound insulation, etc.), protection (abrasion resistance, tensile resistance, penetration resistance, etc.), heat radiation, shielding, waterproofing, etc. for the electrical wires 20. An appropriate one of the functions of the sheet material 12 is selected according to, for example, the properties of the electrical wires 20 and an environment in a position where the electrical wires 20 are disposed. Herein, the sheet material 12 is formed into a rectangular shape as illustrated in FIG. 1. The shape of the sheet material 12 is not limited to the aforementioned shape, but can be appropriately changed according to, for example, an arrangement form of the electrical wires 20.

The sheet material 12 is formed of a material of a resin such as polyethylene terephthalate (PET), polyethylene (PE), or polypropylene (PP). In this case, the resin material may also be a foam resin. It is also considered that the resin material is modified for purpose of improving bonding characteristics, for example. For example, it is known that polyolefin-series resin such as PE and PP has improved bonding characteristics by being modified by maleic acid.

The sheet material 12 may be formed by extrusion molding and have an even cross section, or also may be a non-woven cloth. There is also a case where the sheet member 12 contains a metal material such as aluminum foil. Applicable in this case is that a resin layer coats a surface of the metal material, for example, so that a part of the sheet material 12 coming in contact with the electrical wires 20 is made of resin.

The electrical wires 20 are disposed to have an overlap with the sheet material 12 in at least a part of a region along a longitudinal direction. In the example illustrated in FIG. 1, the electrical wires 20 are disposed only on a side of one main surface 12a of the sheet material 12, but may halfway transfer to a side of the other main surface 12b. The number of the electrical wires 20 may be at least one. Herein, the number of the electrical wires 20 is two or more (three in the example illustrated in FIG. 1). Adopted as the electrical wires 20 are insulated electrical wires 20 each including a core wire 22 and an insulating covering 24 directly covering the core wire 22. The core wire 22 is made of a conductive material such as copper or aluminum. The core wire 22 may be a solid wire or a stranded wire. The insulating covering 24 is considered to be formed by extrusion-molding resin such as polyvinyl chloride (PVC), PE, and PP around the core wire 22. In this case, the resin material may be bridged for improving heat resistance. The insulating covering 24 may also be formed by baking varnish, for example, applied around the core wire 22.

The holding part 30 is an example of an electrical wire-side holding part provided on the electrical wires 20 for fixing the electrical wires 20 to the sheet material 12. The holding part 30 is provided on an outer periphery of the electrical wires 20. The holding part 30 includes at least an intervening part 32 intervening between the electrical wires 20 and the sheet material 12. At least a part of the intervening part 32 in the holding part 30 is welded to the sheet material 12 by ultrasonic welding or laser welding. Accordingly, the holding part 30 is fixed to the sheet material 12, thus the electrical wires 20 are fixed to the sheet material 12.

Herein, the holding part 30 is provided over the whole periphery of the electrical wires 20. At this time, a thickness of the holding part 30 along a circumferential direction may be constant, or may also partially vary. When the thickness of the holding part 30 along the circumferential direction partially varies, it is considered a thickness of the intervening part 32 is larger than a thickness of the other part, for example. Accordingly, the insulating covering 24 hardly melts when the intervening part 32 is welded to the sheet material 12.

Herein, the holding part 30 is continuously provided along a longitudinal direction of the electrical wires 20. At this time, the thickness of the holding part 30 along the longitudinal direction may be constant, or may also partially vary.

Such a holding part 30 can be formed by extrusion-molding resin around the electrical wires 20, for example. However, the holding part 30 may be formed by applying resin around the electrical wires 20, for example, in the manner similar to a holding part 130 according to a second embodiment described hereinafter.

The holding part 30 may be or may not be bonded to an outer peripheral surface of the insulating covering 24. Even when the holding part 30 is not bonded to the outer peripheral surface of the insulating covering 24, it is provided over the whole periphery of the electrical wires 20, thus hardly gets out of the electrical wires 20. The holding part 30 is continuously provided along the longitudinal direction of the electrical wires 20, thus hardly gets out of the electrical wires 20 also on this point, and furthermore, it hardly deviates in the longitudinal direction.

At this time, it is considered to be determined in accordance with a manufacturing method and a material, for example, whether or not the holding part 30 is bonded to the outer peripheral surface of the insulating covering 24. Bonding force in a case where the holding part 30 is bonded to the outer peripheral surface of the insulating covering 24 is also considered to be determined in accordance with a manufacturing method and a material, for example.

For example, in terms of the manufacturing method, it is considered that the outer peripheral surface of the insulating covering 24 is roughly formed, thus the holding part 30 is filled in a minute convexconcave in the outer peripheral surface of the insulating covering 24 at the time of the extrusion molding, and the bonding force between the holding part 30 and the outer peripheral surface of the insulating covering 24 is easily increased by so-called anchor effect. For example, it is considered that the bonding force between the holding part 30 and the outer peripheral surface of the insulating covering 24 is easily increased also by extrusion-molding the holding part 30 around the insulating covering 24 having heat immediately after being extrusion-molded.

For example, in terms of the material, a combination of materials by which a chemical bonding is easily achieved is adopted as that of the insulating covering 24 and the holding part 30, thus the holding part 30 and the outer peripheral surface of the insulating covering 24 are easily bonded to each other. For example, it is considered that the insulating covering 24 and the holding part 30 are chemically bonded easily when the materials thereof are the same in type.

The following combinations are considered as the combinations of the materials by which the chemical bonding is easily achieved when materials different in type are adopted as the materials of the insulating covering 24 and the holding part 30. In the following combinations, the materials are described in order of (the material of the insulating covering 24, the material of the holding part 30).

That is to say, the combinations are (PVC, ethylene-ethyl acrylate copolymer (EEA)) and (PP, maleic acid-modified PP), for example.

Ultrasonic welding is adopted herein as the means of welding the holding part 30 and the sheet material 12. FIG. 4 is an explanation drawing illustrating an implementation of the ultrasonic welding. As illustrated in FIG. 4, the ultrasonic welding is generally performed by sandwiching two members (the electrical wires 20 with the holding part 30 and the sheet material 12 herein) to be welded to each other between a horn 82 and an anvil 84 in an ultrasonic welding machine 80. The two members are located between the horn 82 and the anvil 84 so that surfaces of the two members to be welded are in direct contact with each other.

The horn 82 is in direct contact with one member in the two members, and provides the one member with ultrasonic vibration. Examples of a transmission form of the ultrasonic vibration from the horn 82 include longitudinal vibration and lateral vibration, for example, however, the transmission form can be appropriately selected in accordance with shapes and physical properties of members to be welded.

The anvil 84 supports the other member in the two members. In the example illustrated in FIG. 4, an electrical wire 20 supporting surface of the anvil 84 is formed to have a flat surface, but may also be formed to have a curved surface.

When the ultrasonic vibration is applied from the horn 82 to the one member while the two members to be welded are sandwiched between the horn 82 and the anvil 84, a friction or compression occurs due to the applied ultrasonic vibration, and heat energy is generated. Accordingly, a part of a direct contact surface is melted by the heat energy, and the two members are bonded. Only one of the two members may be melted, or both of the two members may be melted. It is considered to be determined in accordance with physical properties of materials constituting the two members, for example.

Herein, in the ultrasonic welding, a mark made by pressing the horn 82 (referred to as a horn mark 14 hereinafter) may be generally left on the member. Accordingly, the horn mark 14 may also be left in the wire harness 10. It is considered that the horn mark 14 has a shape corresponding to a concave-convex shape formed on the horn 82, for example.

A region of the electrical wires 20 welded to the sheet material 12 in the longitudinal direction may seamlessly extend along the longitudinal direction of the electrical wires 20 in series, or may include a section partially disconnected along the longitudinal direction of the electrical wires 20. In the example illustrated in FIG. 2, the ultrasonic welding is intermittently performed to include the section partially disconnected along the longitudinal direction of the electrical wires 20. At this time, a range of one welding point and an interval of the adjacent welding points, for example, may be appropriately set in accordance with a bonding strength, for example. In the example illustrated in FIG. 2, the ultrasonic welding is intermittently performed at a constant pitch along the longitudinal direction of the electrical wires 20, however, there may also be a part where the ultrasonic welding is performed at a different pitch.

Herein, as illustrated in FIG. 3, the region of the holding part 30 welded to the sheet material 12 in the circumferential direction of the electrical wires 20 is smaller than a quarter of a periphery of the holding part 30. However, the region welded to the sheet material 12 may be larger than the region illustrated in FIG. 3.

In welding the holding part 30 and the sheet material 12 by the ultrasonic welding, at least one of the holding part 30 and the sheet material 12 includes a thermoplastic resin in the direct contact surface. It is preferable that both the two members include the thermoplastic resin on their direct contact surfaces. It is particularly preferable that the material of the holding part 30 is the same as the material of the sheet material 12. The following combinations are considered as the preferable combinations of the materials of the holding part 30 and the sheet material 12 when the materials of the insulating covering 24 and the sheet material 12 are different in type. In the following combinations, the materials are described in order of (the material of the holding part 30, the material of the sheet material 12).

That is to say, considered as the combination are (EEA, PE) and (maleic acid-modified PP, PET), for example.

Accordingly, when added are the combinations of materials by which the chemical bonding is easily achieved as the materials of the insulating covering 24 and the holding part 30 described above, the following combinations are considered as the preferable combinations of the materials of the insulating covering 24, the holding part 30, and the sheet material 12. In the following combinations, the materials are described in order of (the material of the insulating covering 24, the material of the holding part 30, the material of the sheet material 12).

That is to say, considered as the combination are (PVC, EEA, PE) and (PP, maleic acid-modified PP, PET), for example.

Herein, when the materials of the insulating covering 24 and the sheet material 12 are different in type, it is preferable that the material of the holding part 30 is welded more easily to the material of the sheet material 12 than the material of the insulating covering 24 to the material of the sheet material 12. Accordingly, the bonding strength in the case of welding the holding part 30 and the sheet material 12 can be increased compared with the case of welding the insulating covering 24 and the sheet material 12. For example, in the case where the materials of the insulating covering 24 and the sheet material 12 are different in type, the material of the holding part 30 is welded more easily to the material of the sheet material 12 than the material of the insulating covering 24 to the material of the sheet material 12 when the material of the holding part 30 is the same as the material of the sheet material 12.

The characteristics of the resin such as whether it has crystalline nature or non-crystalline nature and a polar character or not, a closeness between melting points or glass-transition points of the resins, and compatibility, for example, are considered to have a relationship with a determination whether the materials of the holding part 30 and the sheet material 12 are easily welded when they are different in type. For example, the materials can be deemed to be welded easily when the higher bonding strength is obtained in the welding part where the holding part 30 and the sheet material 12 are welded than in the welding part where the insulating covering 24 and the sheet material 12 are welded under the same condition other than the materials.

The electrical wires 20 may be power wires or signal wires regarding a usage. The electrical wires 20 may be thick or thin regarding a thickness. The electrical wires 20 may be round wires or angular wire regarding a cross-sectional shape. Herein, it is preferable that each of the direct contact surfaces of the two members at the time of starting the ultrasonic welding generally has a convex shape to reduce a contact area. From this point of view, the round wire has the convex shape in any position in the circumferential direction, thus the holding part 30 provided on the outer periphery of the electrical wires 20 can also be formed in the convex shape easily. Accordingly, the round wire has a shape suitable for the ultrasonic welding.

Ends of the electrical wires 20 described above are incorporated into connectors 26 herein. While the wire harness 10 is disposed in an arrangement target portion in a vehicle, etc., the connectors 26 are connected to the connectors 26 of the various electrical devices mounted on the vehicle, for example. Consequently, the wire harness 10 is used as the wiring for electrically connecting the various electrical devices mounted on the vehicle, for example. The connectors 26 may be of a type having a pressure contact terminal connected with the electrical wire 20 by pressure contactor a type housing a crimp terminal crimped onto the ends of the electrical wire 20.

In the example illustrated in FIG. 1, the ends of the electrical wires 20 are incorporated into the connectors 26 while extending outside the sheet material 12, however, this configuration is not necessary. The ends of the electrical wires 20 may be incorporated into the connectors 26 while being located on the sheet material 12. In this case, there may be a case where a part of the connector 26 is located on the sheet material 12. Further in this case, there may be a case where a part of the connector 26 is bonded and fixed to the sheet material 12.

In the example illustrated in FIG. 2 herein, all of the three electrical wires 30 are fixed to the sheet material 12 via the holding part 30 by welding. However, when the wire harness 10 includes the plurality of electrical wires 20, the wire harness 10 may include the electrical wires 20 which are not fixed to the sheet material 12 by welding. All of the three electrical wires 20 are fixed by welding in the similar manner in the example illustrated in FIG. 2. When the wire harness 10 includes the plurality of electrical wires 20 fixed to the sheet material 12 by welding, at least some of the welding forms such as a welding means and a welding region may be different between the welded electrical wires 20.

All of the three electrical wires 20 are connected to the same connectors 26 in the example illustrated in FIG. 2. When the wire harness 10 includes the plurality of electrical wires 20, the wire harness 10 may include the electrical wires 20 connected to the different connectors 26.

The electrical wires 20 are linearly disposed in the example illustrated in FIG. 1. The electrical wires 20 may be curvedly disposed. When the wire harness 10 includes the plurality of electrical wires 20, the electrical wires 20 linearly disposed and the electrical wires 20 curvedly disposed may coexist. In this case, branches may be formed in the plurality of electrical wires 20 on the sheet material 12.

In the example illustrated in FIG. 1, the electrical wires 20 are disposed close to a center of the sheet material 12 in a width direction. However, a path of the electrical wires 20 disposed on the sheet material 12 is not limited thereto described above. The electrical wires 20 may be disposed, for example, close to an end of the sheet material 12 in the width direction. The electrical wires 20 may, for example, extend diagonally to the sheet material 12.

In the example illustrated in FIG. 1, the sheet material 12 is flat, however, the sheet material 12 may be rounded around the electrical wires 20. At this time, the sheet material 12 may include a flat part and a rounded part. When the wire harness 10 is disposed along a rod-like member, at least a part of the sheet material 12 is wound around the rod-like member.

A fixing member for fixing the wire harness 10 to a mounting object such as a vehicle body panel or the rod-like member may be provided on the sheet material 12. At this time, the fixing member may also be bonded to the sheet material 12.

In the above configuration, the holding part 30 provided on the outer periphery of the insulating covering 24 is welded to the sheet material 12, thus the insulating covering 24 hardly melts. Thus, sufficient insulation properties can be ensured after welding.

The holding part 30 is provided over the whole periphery of the electrical wires 20, thus hardly gets out of the electrical wires 20 even when the holding part 30 is not bonded to the insulating covering 24. When the thickness of the holding part 30 is constant along the circumferential direction, for example, an optional position in the electrical wires 20 with the holding part 30 along the circumferential direction can be welded to the sheet material 12.

The holding part 30 is continuously provided along the longitudinal direction of the electrical wires 20, thus an optional position in the holding part 30 along the longitudinal direction of the electrical wires 20 can be welded to the sheet material 12. The holding part 30 hardly gets out of the electrical wires 20 even when the holding part 30 is not bonded to the insulating covering 24.

The holding part 30 is formed of a material welded more easily to the sheet material 12 than the insulating covering 24 to the sheet material 12, thus sufficient holding strength can, easily be, obtained between the electrical wires 20 and the exterior member after welding.

### Second Embodiment

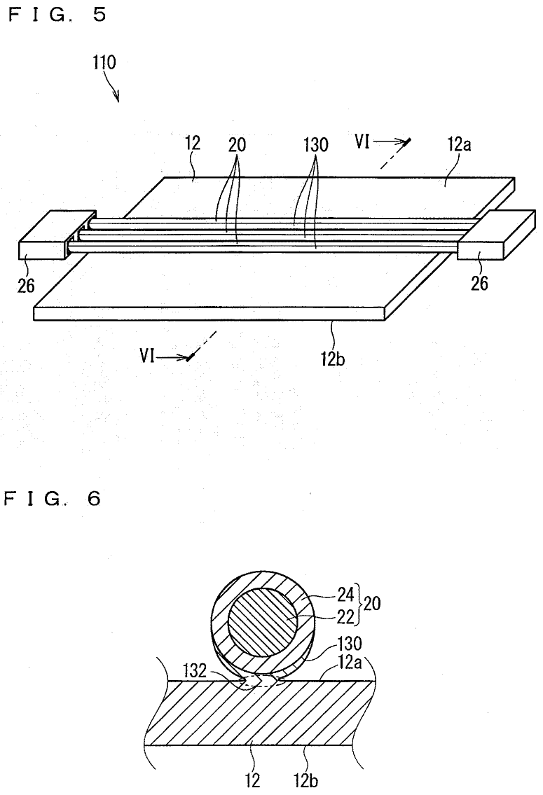

A wire harness according to a second embodiment is described. FIG. 5 is a perspective view illustrating a wire harness 110 according to the second embodiment. FIG. 6 is a cross-sectional view of the wire harness 110 cut along a VI-VI line in FIG. 5. A part surrounded by an imaginary line in FIG. 6, in the manner similar to the case in FIG. 3, indicates a position where the sheet material 12 and a holding part 130 are welded to each other. In the description of the present embodiment, the same reference numerals are assigned to the similar constituent elements described above, and the description thereof will be omitted.

In the wire harness 110 according to the present embodiment, a shape of the holding part 130 is different from that of the holding part 30 in the wire harness 10 according to the first embodiment.

Specifically, the holding part 130 is provided only in a part of a region in the electrical wires 20 along the circumferential direction while including an intervening part 132. In the example illustrated in FIG. 6, the holding part 130 is provided in a region over a half the periphery of the electrical wires 20 along the circumferential direction, however, the holding part 130 may be provided in a wider region than the region described above, or may also be provided in a narrower region. The holding part 130 is preferably provided so that the electrical wires 20 do not come in contact with the sheet material 12 at least at the time of welding.

The holding part 130 is continuously provided along the longitudinal direction of the electrical wires 20 in the manner similar to the holding part 30 in the wire harness 10 according to the first embodiment.

The holding part 130 is formed by coating the periphery of the electrical wires 20 with a resin, for example. At this time, the holding part 130 is provided only on part of a region in the electrical wires 20 along the circumferential direction, thus there is a possibility that the holding part 130 gets out of the insulating covering 24. It is preferable that the bonding strength between the holding part 130 and the insulating covering 24 is increased by the method described above to prevent the holding part 130 from getting out of the insulating covering 24.

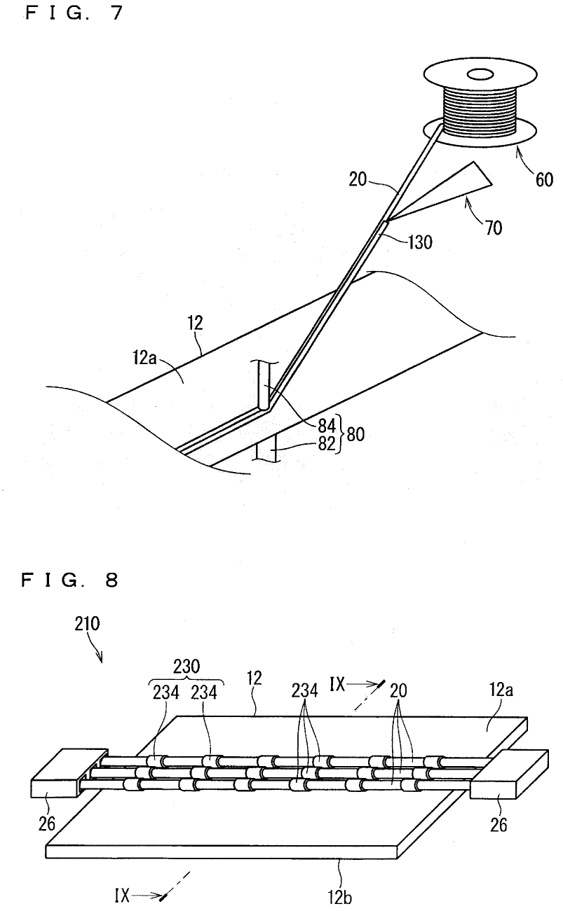

When the wire harness 110 according to the present embodiment is manufactured, it is considered as illustrated in FIG. 7 to perform a step of providing the holding part 130 on the outer periphery of the electrical wires 20 and a step of welding the holding part 130 and the sheet material 12 together during the same step of reeling out the electrical wires. That is to say, both a resin supply part 70 and the welding machine 80 are provided in one electrical wire reeling-out line reeled out from an electrical wire housing 60 housing the electrical wires 20 in one manufacturing device. The resin supply part 70 is a part supplying a resin which is to be the holding part 130 around the electrical wires 20. The resin supply part 70 supplies the resin around the electrical wires 20 by applying it, for example. The welding machine 80 is the ultrasonic welding machine 80 described above, for example, and is provided on a downstream side of the resin supply part 70. As described above, performed together during the same step of reeling out the electrical wires are the step of providing the holding part 130 on the outer periphery of the electrical wires 20 and the step of welding the holding part 130 and the sheet material 12, thus a lead time can be reduced and the device can be simplified compared with a case of providing the holding part 130 on the outer periphery of the electrical wires 20 and reeling off the electrical wires 20 once, and subsequently reeling out again the electrical wires 20 which was reeled off at the time of welding the holding part 130 and the sheet material 12. The holding part 130 and the sheet material 12 can be welded immediately after providing the holding part 130 on the outer periphery of the electrical wires 20, thus it can be suppressed that the part of the electrical wires 20 where the holding part 130 is not provided along the circumferential direction is welded to the sheet material 12.

According to the present configuration, the holding part 130 is provided only in the part of the region of the electrical wires 20 along the circumferential direction, thus a material saving and a weight saving can be achieved.

### Third Embodiment

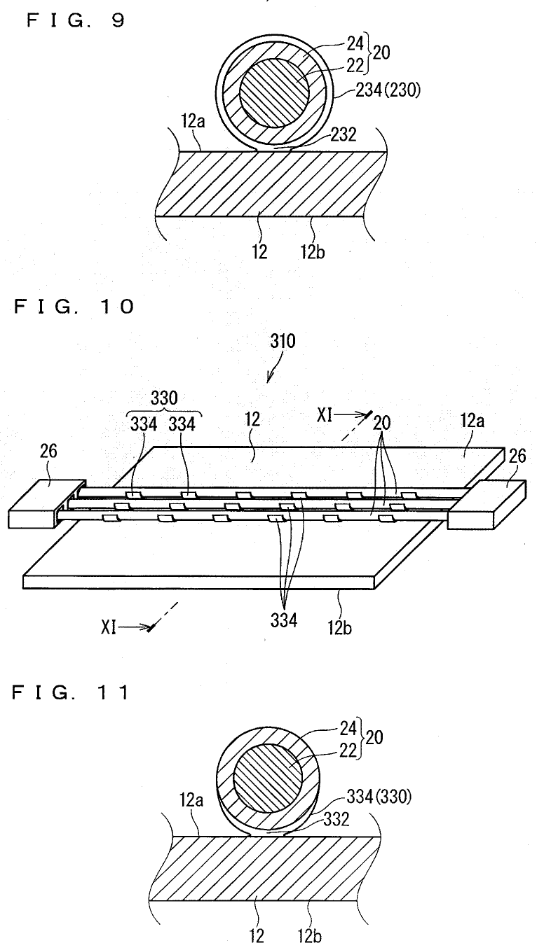

A wire harness according to a third embodiment is described. FIG. 8 is a perspective view illustrating a wire harness 210 according to the third embodiment. FIG. 9 is a cross-sectional view of the wire harness 210 cut along a IX-IX line in FIG. 8. FIG. 9 is a cross-sectional view of a part of the electrical wires 20 where a holding part 230 is not provided along the longitudinal direction. In the description of the present embodiment, the same reference numerals are assigned to the similar constituent elements described above, and the description thereof will be omitted.

In the wire harness 210 according to the present embodiment, a shape of the holding part 230 is different from that of the holding part 30 in the wire harness 10 described above.

Specifically, the holding part 230 is intermittently provided along the longitudinal direction of the electrical wires 20. Herein, each divided unit of the holding part 230 is referred to as a holding piece 234. In the example illustrated in FIG. 8, the holding piece 234 is provided at a constant pitch along the longitudinal direction of the electrical wires 20, but may also be provided at a different pitch.

When the holding part 230 is intermittently provided along the longitudinal direction of the electrical wires 20, all of the holding pieces 234 may be welded to the sheet material 12, or there may be the holding piece 234 which is not welded to the sheet material 12.

Each holding piece 234 is provided over the whole periphery of the electrical wires 20 in the manner similar to the holding part 30 in the wire harness 10 according to the first embodiment while including an intervening part 232. At this time, each holding piece 234 has a constant thickness in the circumferential direction; however, it may have a part having a different thickness in the circumferential direction in the manner similar to the holding part 30 in the wire harness 10 according to the first embodiment.

The holding part 230 is formed by coating the electrical wires 20 with a resin in the manner similar to the holding part 130 according to the second embodiment, for example. More specifically, alternately repeated are a state where the electrical wires 20 which are reeled out are coated and a state where they are not coated. When the electrical wires 20 are coated with the resin, the whole periphery of the electrical wires 20 is coated.

According to the present configuration, the holding part 230 is intermittently provided along the longitudinal direction of the electrical wires 20, thus a material saving and a weight saving can be achieved.

### Fourth Embodiment

A wire harness 310 according to a fourth embodiment is described. FIG. 10 is a perspective view illustrating the wire harness 310 according to the fourth embodiment. FIG. 11 is a cross-sectional view of the wire harness 310 cut along an XI-XI line in FIG. 10. FIG. 11 is a cross-sectional view of a part of the electrical wires 20 where a holding part 330 is not provided along the longitudinal direction. In the description of the present embodiment, the same reference numerals are assigned to the similar constituent elements described above, and the description thereof will be omitted.

In the wire harness 310 according to the present embodiment, a shape of the holding part 330 is different from that of the holding part 30 in the wire harness 10 described above.

Herein, the holding part 330 is intermittently provided along the longitudinal direction of the electrical wires 20. The holding part 330 is provided only on part of a region in the electrical wires 20 along the circumferential direction. Accordingly, the holding part 330 includes a plurality of holding pieces 334 provided with a space therebetween along the longitudinal direction of the electrical wires 20. Each holding piece 334 covers only a part of a region in the electrical wires 20 along the circumferential direction while including an intervening part 332.

The holding part 330 is formed by coating the electrical wires 20 with a resin in the manner similar to the holding part 130 according to the second embodiment, for example. More specifically, alternately repeated are a state where the electrical wires 20 which are reeled out are coated and a state where they are not coated. When the electrical wires 20 are coated with the resin, a part of a region in the electrical wires 20 is coated.

According to the present configuration, the holding part 330 is intermittently provided along the longitudinal direction of the electrical wires 20, thus a material saving and a weight saving can be achieved.

The holding part 330 is provided only in the part of the region of the electrical wires 20 along the circumferential direction, thus a material saving and a weight saving can be achieved.

### Fifth Embodiment

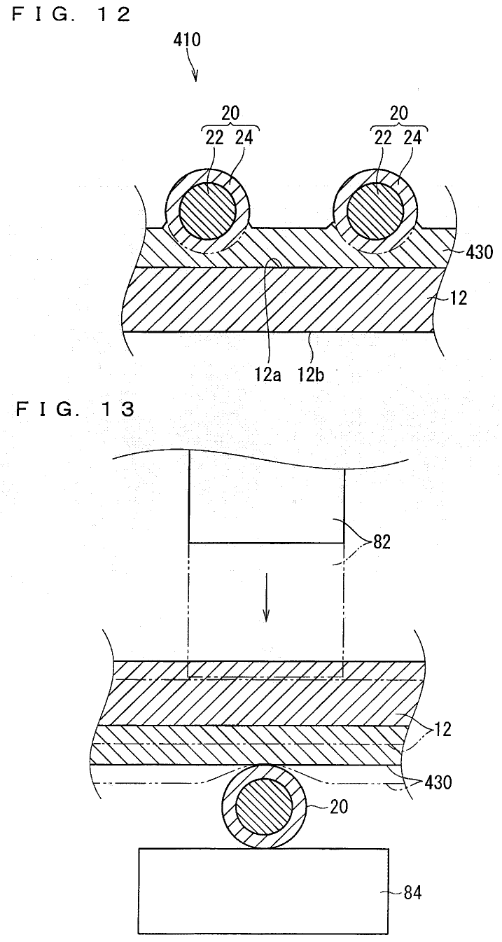

A wire harness 410 according to a fifth embodiment is described. FIG. 12 is a cross-sectional view illustrating the wire harness 410 according to the fifth embodiment. FIG. 13 is an explanation diagram illustrating a manufacture of the wire harness 410 according to the fifth embodiment. In the description of the present embodiment, the same reference numerals are assigned to the similar constituent elements described above, and the description thereof will be omitted.

The wire harness 410 according to the fifth embodiment is different from the wire harnesses 10, 110, 210, and 310 in that a holding part 430 is provided on the sheet material 12.

The holding part 430 is an example of a sheet material-side holding part provided on the sheet material 12 for fixing the sheet material 12 to the electrical wires 20. It is considered that the holding part 430 is provided over the whole one main surface 12a of the sheet material 12, for example. It is also considered, for example, that the holding part 430 is provided on a part of the one main surface 12a of the sheet material 12 including a part where the electrical wires 20 are disposed. At this time, the holding part 430 may be formed to have an even thickness, or may also have a part which partially has a different thickness.

The holding part 430 is formed of a material including a thermoplastic resin, for example. The holding part 430 is formed by applying the material including the thermoplastic resin to the one main surface 12a of the sheet material 12, for example. The holding part 430 is formed by two-color molding or extrusion molding together with the sheet material 12. Accordingly, the sheet material 12 and the holding part 430 are bonded to be integral with each other.

The holding part 430 is formed using, as a base, the same resin as the resin used in the sheet material 12 as a base. At this time, the holding part 430 is formed softer than the sheet material 12. Herein, the resin used as a base is PVC, and a ratio of a plasticizer which is added is increased, thus the holding part 430 is made softer than the sheet material 12. A type of the plasticizer is not particularly limited, and applicable is a plasticizer such as phthalic acid esters, trimellitic acid esters, pyromellitic acid esters, fatty acid esters, and fatty acid polyesters, for example. One type of the plasticizer may be solely used, or plural types of the plasticizers may also be used together. However, a means of making the resin used as the base and the holding part 430 softer than the sheet material 12 is not limited thereto. For example, PE, PP, and PET, for example, are also considered as the resin used as the base. A means of making the holding part 430 softer than the sheet material 12 is set in accordance with the resin used as the base, and also considered as the means thereof is a means of, for example, reducing density of the resin used as the base, copolymerizing the other resin, or adding a modifier capable of increasing plasticity (for example, an olefin-series or styrene-series thermoplastic elastomer).

Herein, the resin used in the insulating covering 24 as the base is the same as the resin used in the holding part 430 as the base. Accordingly, the insulating covering 24 and the holding part 430 are successfully welded. The resin used in the insulating covering 24 as the base may be different from the resin used in the holding part 430 as the base.

Considered in bonding the electrical wires 20 to the sheet material 12 provided with such a holding part 430 is that an intervening part 432 in the holding part 430 and the insulating covering 24 are welded by ultrasonic welding or laser welding (the ultrasonic welding in the example illustrated in FIG. 5) in a state where the electrical wires 20 is disposed on the holding part 430. At this time, when the electrical wires 20 and the intervening part 432 are sandwiched and pressed from both sides, the intervening part 432 warps by reason that the holding part 430 is softer than the sheet material 12 and the core wire 22, and the electrical wires 20 are located closer to the sheet material 12 than a lateral part of the intervening part 432 in the holding part 430. When the welding is performed in this state, the electrical wires 20 are buried in the holding part 430, and a welding region in the circumferential direction of the electrical wires 20 increases. As a result, the welded area increases, thereby being able to increase the bonding strength.

At this time, a degree of burying the electrical wires 20 is considered to be determined in accordance with the thickness, plasticity, and pressing force on the holding part 430. The welded area increases as the degree of burying the electrical wires 20 gets larger, thus it is preferable that the degree of burying the electrical wires 20 is large. For example, in the example illustrated in FIG. 12, a region equal to or larger than a quarter of the periphery of the electrical wires 20 and smaller than a half the periphery thereof is buried. At this time, also considered is that a region equal to or larger than the half the periphery of the electrical wires 20 is buried. In this case, a concave portion is fitted in a convex portion having a narrow inlet, thus even when a welding state between the holding part 430 and the insulating covering 24 is dissolved, the holding part 430 hardly gets out of the insulating covering 24. From this viewpoint, also considered is that a region of the whole periphery of the electrical wires 20 is buried. In this case, the thickness of the holding part 430 previously provided on the sheet material 12 is set to be equal to or larger than a diameter of the electrical wire.

However, the structure of burying the electrical wires 20 in the holding part 430 after welding is not necessary, thus the electrical wires 20 may not be buried in the holding part 430.

Also considered to achieve the structure of burying the electrical wires 20 in the holding part 430 after welding is that a concave portion is previously formed in the holding part 430 and the welding is performed in a state of burying the electrical wires in the concave portion 20. In this case, the holding part 430 needs not be softer than the sheet material 12.

In terms of insulation properties, it is preferable that the insulating covering 24 does not melt as much as possible at the time of welding the holding part 430 and the insulating covering 24. In this case, for example, it is considered that a melting point (softening point) of the holding part 430 is set to be lower than a melting point (softening point) of the insulating covering 24.

The firm bonding between the electrical wires 20 and the sheet material 12, using the ultrasonic welding or the laser welding, can also be achieved by the wire harness 410 having such a configuration when the holding part 430 intervening between the electrical wires 20 and the sheet material 12 is formed of a material having favorable bonding characteristics with a material of a member to which the holding part 430 is welded by the ultrasonic welding and or the laser welding, for example.

Particularly, the sheet material 12 and the electrical wires 20 can be welded by the ultrasonic welding or the laser welding using the holding part 430 previously provided on the sheet material 12.

At least the part of the electrical wires 20 is buried in the holding part 430, thus the welding area between the electrical wires 20 and the holding part 430 can be increased. Accordingly, the bonding strength can be increased.

The holding part 430 is formed softer than the sheet material 12 while using, as the base, the same resin as the resin which is used in the sheet material 12 as the base, thus when the bonding portion between the electrical wires 20 and the sheet material 12 is pressed and the bonding is performed in the state where the holding part 430 warps at the time of the ultrasonic welding or the laser welding, the structure of burying the electrical wires 20 in the holding part 430 can be simply formed.

The resin used in the insulating covering 24 as the base is the same as the resin used in the holding part 430 as the base, thus the electrical wires 20 and the holding part 430 can be welded easily. Accordingly, the bonding strength can be increased.

### Modification Example

In the description of the first embodiment, the ultrasonic welding is adopted as the means of welding the holding part 30 and the sheet material 12, however, this configuration is not necessary. Laser welding may also be adopted as the means of welding the holding part 30 and the sheet material 12. The same applies to the other embodiments. In this case, laser light is emitted from a side of one of the holding part 30 and the sheet material 12 toward an interface therebetween. The member on the side from which the laser light is emitted is formed of a laser light-transmissive material. At least a surface of the other one of them at the interface can absorb more laser light than a surface of one of them. Accordingly, the laser light is absorbed at the interface, and the holding part 30 and the sheet material 12 are welded by the absorbed light. Any of the holding part 30 and the sheet material 12 may be the member located on the laser light-transmissive side.

It is also considered that a resin material having high heat conductivity is used as the material of the holding part 30. Accordingly, an effect of radiating heat of the electrical wires 20 can be enhanced. Examples of the resin material having the high heat conductivity include a combination of the resin described above and a heat-conductive filler such as alumina and boron nitride.

Applicable in the manufacturing method according to each embodiment is that the sheet material 12 having an elongated shape is reeled out and the electrical wires 20 with the holding part 30 are welded thereto, and subsequently the sheet material 12 is cut to a predetermined size, or the electrical wires 20 with the holding part 30 are welded to the sheet material 12 being cut to a predetermined size.

When the part of the electrical wires 20 extends from the sheet material 12, the holding part 30 may not be provided in a part of the electrical wires 20 extending outside the sheet material 12.

In the description of the fourth embodiment, the holding part 430 is formed using, as the base, the same resin as the resin which is used in the sheet material 12 as the base, however, this configuration is not necessary. There may be a case where the holding part 430 is formed using, as a base, a resin different from a resin which is used in the sheet material 12 as a base. In this case, a combination of the materials of the holding part 430, the sheet material 12, and the insulating covering 24 is considered to be similar to that described in the first embodiment.

In the above description, the ultrasonic welding and the laser welding are illustrated as the welding means by the example. The welding may also be performed using a heating means such as condensing heating, hot-air heating, induction heating, and dielectric heating.

The configurations described in the embodiments and modification examples thereof can be appropriately combined as long as they are not contradictory. For example, both the electrical wire-side holding part and the sheet material-side holding part may be adopted in one wire harness. In this case, the electrical wire-side holding part and the sheet material-side holding part are welded.

Although the present invention is described in detail, the foregoing description is in all aspects illustrative and does not restrict the invention. It is therefore understood that numerous modifications and variations can be devised without departing from the scope of the invention.

### EXPLANATION OF REFERENCE SIGNS

10 wire harness

12 sheet material

12a one main surface

12b other main surface

14 horn mark

20 electrical wire

22 core wire

24 insulating covering

26 connector

30 holding part

32 intervening part

34 holding piece

60 electrical wire housing

70 resin supply part

80 ultrasonic welding machine

82 horn

84 anvil

1. (canceled)

2. A wire harness, comprising:
a sheet material;
an electrical wire including a core wire and an insulating covering which directly covers a periphery of the core wire and disposed along the sheet material; and
a holding part, at least a part of which intervenes between the electrical wire and the sheet material to mediate a bonding between the sheet material and the electrical wire by welding, wherein
the holding part includes a sheet material-side holding part provided on the sheet material, and
a resin used in the insulating covering as a base is identical with the resin used in the sheet material-side holding part as a base.

3. The wire harness according to claim 2, wherein
at least part of the electrical wire is buried in the sheet material-side holding part.

4. The wire harness according to claim 3, wherein
the sheet material-side holding part is formed softer than the sheet material while using, as a base, a resin identical with a resin used in the sheet material as a base.

5. (canceled)

6. The wire harness according to claim 2, wherein
the holding part includes an electrical wire-side holding part provided on the electrical wire to fix the electrical wire to the sheet material.

7. The wire harness according to claim 6, wherein
the electrical wire-side holding part is continuously provided along a longitudinal direction of the electrical wire.

8. The wire harness according to claim 6, wherein
the electrical wire-side holding part is intermittently provided along a longitudinal direction of the electrical wire.

9. The wire harness according to claim 6, wherein
the electrical wire-side holding part is provided over a whole periphery of the electrical wire.

10. The wire harness according to claim 6, wherein
the electrical wire-side holding part is provided only on part of a region in the electrical wire along a circumferential direction.

11. The wire harness according to claim 6, wherein
the insulating covering and the sheet material are formed by materials different in type, and
the electrical wire-side holding part is formed of a material welded more easily to the sheet material than the insulating covering to the sheet material.

12. The wire harness according to claim 2, wherein
the holding part mediates a bonding between the sheet material and the electrical wire by ultrasonic welding or laser welding.

13. (canceled)

14. A method of manufacturing a wire harness, comprising:
providing a holding part on at least one of a sheet material and an electrical wire; and
of making the holding part intervene between the sheet material and the electrical wire and melting the holding part, thereby bonding the sheet material and the electrical wire with the holding part therebetween, wherein
the providing the holding part includes
providing the holding part including a resin, as a base, identical with a resin used in an the insulating covering of the electrical wire as a base on the sheet material.

15. The method of manufacturing the wire harness according to claim 14, wherein
the providing the holding part includes
providing the holding part on a periphery of the electrical wire, and
performing the providing the holding part on the periphery of the electrical wire and the making the holding part intervene between the sheet material and the electrical wire and melting the holding part together during a reeling out of the electrical wire.
